(19) United States
(12) Patent Application Publication
(10) Pub. No.: US 2012/0054163 A1
(43) Pub. Date: Mar. 1, 2012

(54) POLICY CONFLICT CLASSIFIER

(75) Inventors: Yan Liu, Hanover Park, IL (US); Zhi Fu, Herndon, VA (US); Kabe Vanderbaan, Arlington Heights, IL (US)

(73) Assignee: MOTOROLA, INC., Schaumburg, IL (US)

(21) Appl. No.: 12/869,958

(22) Filed: Aug. 27, 2010

(51) Int. Cl. G06F 17/30

(52) U.S. Cl. 707/694; 707/E17.007

(57) ABSTRACT

In a method for classifying policy conflicts in a managed system, a plurality of separate attributes of a policy rule is identified. The plurality of separate attributes is compared with attributes of previously stored policies rules to determine whether one or more policy conflicts exist. In response to a determination that one or more policy conflicts exist, the one or more policy conflicts are classified according to a predefined schedule.

### BACKGROUND

A “policy” is a set of rules that is used to manage and control the changing and/or maintaining of the state of one or more managed objects or entities. The policy rules comprise events, conditions and actions, in which policy events trigger the evaluation of policy conditions that may lead to the execution of policy actions.

A policy-based management system (PBMS) apparatus typically controls the state of a system containing the managed objects or entities using the policies. The PBMS apparatus is configured to perform various functions in the system, including installing and deleting policy rules, as well as monitoring system performance to ensure that the installed policies are working correctly. The PBMS apparatus is concerned with the overall behavior of the system and adjusts the policies that are in effect based on how well the system is achieving its goals as expressed in the policy rules.

In a policy-based system of significant size, there may be a very large number of policies to support and govern the complex operations of the system. Policy conflicts are inevitable in such a system. Policies may be in conflict with each other, either because of their inherent inconsistencies, human errors, or because of application-specific constraints. However, since policies are potentially complex combinations of events, conditions, and actions, their conflicts may not be easily detected. Such complexity requires that a relatively large amount of resources be employed to detect conflicts in the policies.

### SUMMARY

According to an embodiment, a plurality of separate attributes of a policy rule is identified. A determination as to whether one or more policy conflicts exist is made by comparing the plurality of separate attributes with attributes of previously stored policy rules. In response to a determination that one or more policy conflicts exist, the one or more policy conflicts are classified according to a predefined schedule.

According to another embodiment, a policy conflict classifier that includes one or more modules is disclosed. The one or more modules are configured to identify a plurality of separate attributes of the policy rule, determine whether one or more policy conflicts exist by comparing the plurality of separate attributes with attributes of previously stored policies and, in response to a determination that one or more policy conflicts exist, to classify the one or more policy conflicts according to a predefined schedule. The policy conflict classifier also includes a processor configured to implement the one or more modules.

Still in a further embodiment, a computer readable storage medium on which is embedded one or more computer programs implements the above-disclosed method of classifying policy conflicts in a managed system.

Embodiments of the present invention provide a method and apparatus for classifying policy conflicts. The method and apparatus are generally configured to assist in the identification of specific types of conflicts in a policy specification so that upon receiving detection information for policy conflicts, the policy specification may more easily be corrected as compared with conventional conflict detection systems.

### BRIEF DESCRIPTION OF THE DRAWINGS

Features of the present invention will become apparent to those skilled in the art from the following description with reference to the figures, in which:

FIG. 1 is a block diagram illustrating a policy rule structure, according to an embodiment of the invention;

FIG. 2 illustrates a policy conflict classifier, according to an embodiment of the invention;

FIG. 3 illustrates a flow diagram of a method of classifying policy conflicts, according to an embodiment of the invention,

FIG. 4 illustrates a flow diagram of a method of classifying policy conflicts, according to an embodiment of the invention; and

FIG. 5 shows a block diagram of a computer system that may be used in the classifying policy conflicts, according to an embodiment of the invention.

### DETAILED DESCRIPTION

For simplicity and illustrative purposes, the present invention is described by referring mainly to exemplary embodiments thereof. In the following description, numerous specific details are set forth to provide a thorough understanding of the present invention. However, it will be apparent to one of ordinary skill in the art that the present invention may be practiced without limitation to these specific details. In other instances, well known methods and structures have not been described in detail to avoid unnecessarily obscuring the present invention.

Embodiments of the present invention are directed to a policy-driven system. Such systems may include a communications infrastructure of equipment that is wired, wireless, or a combination thereof. Embodiments of the present invention are configured to access policies and identify a plurality of separate attributes of each policy. The plurality of separate attributes are compared, using a processor, with attributes of previously stored policies to determine whether one or more policy conflicts exist. The one or more existing policy conflicts are classified according to a predefined schedule, in response to a determination that one or more policy conflicts exist.

A policy or a policy rule, which are considered interchangeably herein, may be defined as being composed of event, condition and action elements. According to an example, upon one or more triggering events occurring, if the condition clause evaluates to TRUE, then the actions in the action clause are executed. If the condition clause evaluates to FALSE, then the actions in the action clause are not allowed to execute. Therefore, one definition of policy management is the usage of policy rules to accomplish decisions.

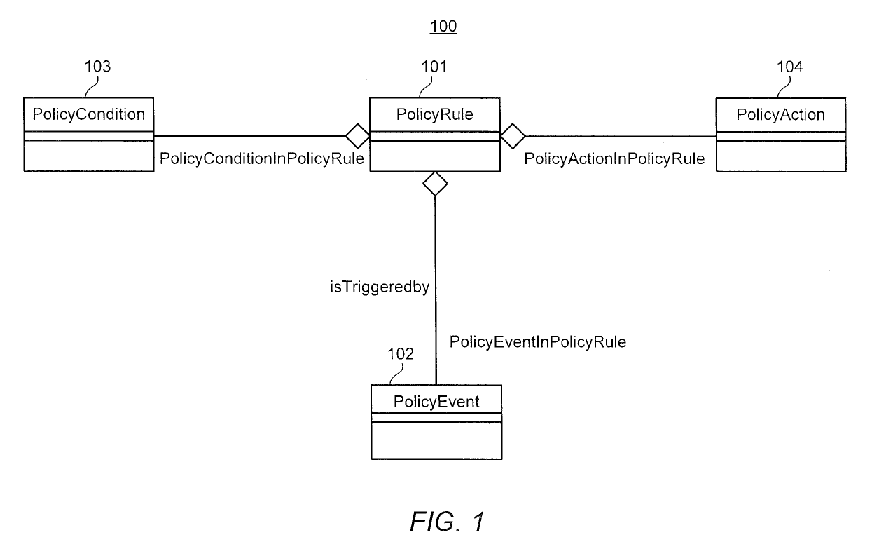

FIG. 1 illustrates a model 100 of a policy rule 101 in accordance with an embodiment of the present invention. The policy rule 101 includes one or more policy events 102, policy conditions 103, and policy actions 104. This Event/Condition/Action 3-tuple is a common definition of a policy rule in the art. For instance, as shown in FIG. 1, a policy condition 103 in the policy rule 101 may be triggered by a policy event 102, causing a policy action 104 to occur. In addition, each of a plurality of policy rules 101 may include respective policy conditions 103, policy events 102, and policy actions 104. The policy rule 101 may be represented as a single event attribute, a single condition attribute, and a single policy attribute. Each attribute may be atomic or complex. For example, an atomic condition may be age <10, and a complex condition may be atomic condition C1 and/or atomic condition C2.

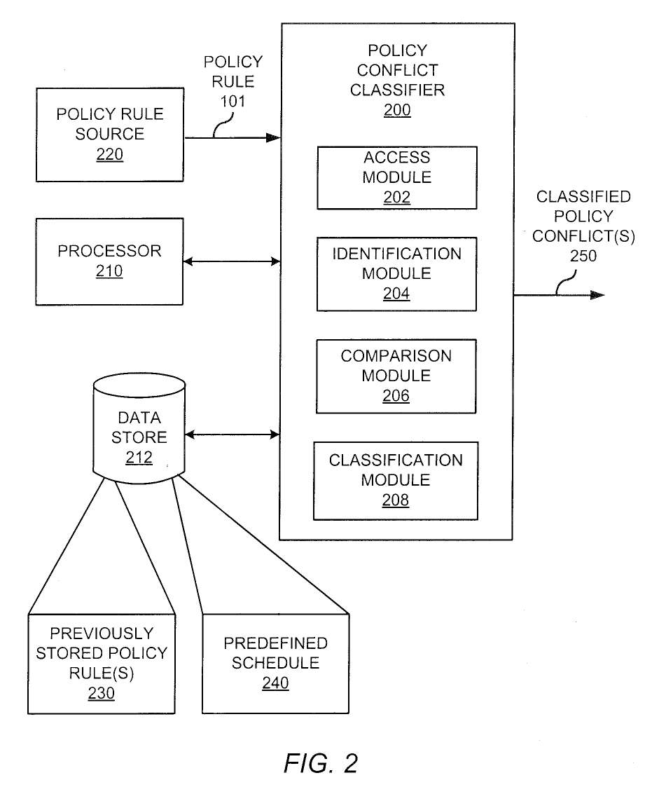

FIG. 2 illustrates a simplified block diagram of a policy conflict classifier 200 configured to classify policy conflicts, according to an embodiment. It should be understood that the policy conflict classifier 200 depicted in FIG. 2 may include additional components and that some of the components described herein may be removed and/or modified without departing from a scope of the policy conflict classifier 200.

The policy conflict classifier 200 is depicted as including an access module 202, an identification module 204, a comparison module 206, and a classification module 208. The modules 202-208 may comprise software modules, hardware modules, or a combination of software and hardware modules. Thus, in one embodiment, one or more of the modules 202-208 comprise circuit components. In another embodiment, one or more of the modules 202-208 comprise software code stored on a computer readable storage medium, which is executable by a processor. As such, in one embodiment, the policy conflict classifier 200 comprises a hardware device. In another embodiment, the policy conflict classifier 200 comprises software stored on a computer readable medium.

In any regard, a processor 210, which may comprise a microprocessor, a micro-controller, an application specific integrated circuit (ASIC), and the like, is configured to implement or invoke the modules 202-208. In addition, the modules 202-208 may be configured to access a data store 212 that stores various information that the modules 202-208 may access. The data store 212 may comprise volatile and/or non-volatile memory, such as DRAM, EEPROM, MRAM, phase change RAM (PCRAM), Memristor, flash memory, and the like. In addition, or alternatively, the data store 116 may comprise a device configured to read from and write to a removable media, such as, a floppy disk, a CD-ROM, a DVD-ROM, or other optical or magnetic media.

The access module 202 is configured to access a policy rule 101, for instance, from a policy rule source 220, which may comprise a user input device, such as a data entry device. Accordingly, the access module 202 may include a Universal Serial Bus (USB), an Ethernet interface, or another type of interface through which the policy conflict classifier 200 may receive the policy rule 101. In addition, or alternatively, the policy rule 101 may have previously been stored (not shown) in the data store 212 and the access module 210 may access or retrieve the policy rule 101. According to an example, the access module 202 is configured to retrieve previously stored policy rules 230, for instance, one by one. In this example, the access module 202 is configured to compare the policy rule 101 with each of the previously stored policy rules 230 one by one to determine if there is a conflict between the policy rule 101 and any one of the previously stored policy rules 230. If the access module 202 determines that the policy rule 101 does not conflict with any of the previously stored policy rules 230, the access module 202 may store the policy rule 101 in the data store 212 as one of the previously stored policies 230.

The identification module 204 is configured to identify a plurality of separate attributes of the policy rule 101. The separate attributes may comprise, for instance, one or more policy events 102, policy conditions 103, and policy actions 104 as well as priority level, access right and time validity for this policy.

The comparison module 206 is configured to compare the plurality of separate attributes with attributes of one or more previously stored policy rules 230 to determine whether one or more policy conflicts exist. As shown in FIG. 2, the previously stored policy rules 230 may be stored in the data store 212. Alternatively, however, the previously stored policy rules 230 may be stored in a separate location. In any regard, the comparison module 206 may compare the one or more policy events 102 of the policy rule 101 with events in the previously stored policy rules 230. Similarly, the comparison module 206 may compare the one or more policy conditions 103 of the policy rule 101 with conditions in the previously stored policy rules 230 and may compare the one or more policy actions 104 of the policy rule 101 with conditions in the previously stored policy rules 230.

The classification module 208 is configured to classify the one or more policy conflicts according to a predefined schedule 240, in response to a determination that one or more policy conflicts exist. As shown in FIG. 2, the predefined schedule 240 may be stored in the data store 212. Alternatively, however, the predefined schedule 240 may be stored in a separate location. In any regard, the predefined schedule may define the policy conflicts as predicate conflicts, modality conflicts, and association assignment conflicts. The predicate conflicts include logical inconsistencies across rule sets. The modality conflicts include conflicting modalities such as time validity conflicts and authorization conflicts. The association assignment conflicts include inconsistent priorities and assignments referring to at least one common rule set. The classification module 208 may output the classified policy conflicts 250 to, for instance, a memory location, a display, a computing device for further processing, etc.

According to an embodiment, the predefined schedule 240 may further define predicate conflicts as one of pre-condition conflicts and post-condition conflicts. The pre-condition conflicts include inconsistencies between event and condition attributes of at least two rule sets and the post-condition conflicts include inconsistencies between action attributes of at least two rule sets.

The predefined schedule 240 may further define pre-condition conflicts as contradictions, correlations, redundancies, or intersections. Contradictions occur when conditions of the policy rule 101 and the previously stored policy rules 230 are a negation of each other and refer to a same event and action. Correlations occur when an event or a condition of the policy rule 101 is a conjunctive subset of another event or condition of the previously stored policy rules 230 and refers to a same event and action. Redundancies occur when an event or a condition of the policy rule 101 is a disjunctive subset of another event or condition of the previously stored policy rules 230 and refers to a same event and action. Intersections occur when an event or a condition of the policy rule 101 intersects with another event or condition and refers to a same event and action.

The predefined schedule 240 may further define post-condition conflicts as contradictions, independencies, redundancies, or correlations. Contradictions occur when action attributes of the policy rule 101 and the previously stored policy rules 230 are mutually exclusive with each other and refer to a same event and condition. Independencies occur when action attributes of the policy rule 101 and the previously stored policy rules 230 are independent and refer to a same event and condition. A redundancy occurs when an action of the policy rule 101 is a subset of another action of a previously stored policy rule 230 and refers to a same event and condition. Correlations occur when actions of the policy rule 101 intersect with other actions of the previously stored policy rules 230 and refer to a same event and condition.

The predefined schedule 240 may further define modality conflicts as time validity conflicts or authorization conflicts. A time validity conflict refers to common policy sets and occur when there are inconsistencies between time validities of the policy rule 101 and previously stored policy rules 230. An authorization conflict occurs when there are inconsistencies between authorizations and obligations of the policy rule 101 and previously stored policy rules 230.

The predefined schedule 240 may further define association assignment conflicts as priority assignment conflicts or access rights conflicts. Priority assignment conflicts refer to common rule sets and occur when there are inconsistencies between priorities of the policy rule 101 and previously stored policy rules 230. Access rights conflicts refer to common rule sets and occur when there are inconsistencies between access rights of the policy rule 101 and previously stored policy rules 230.

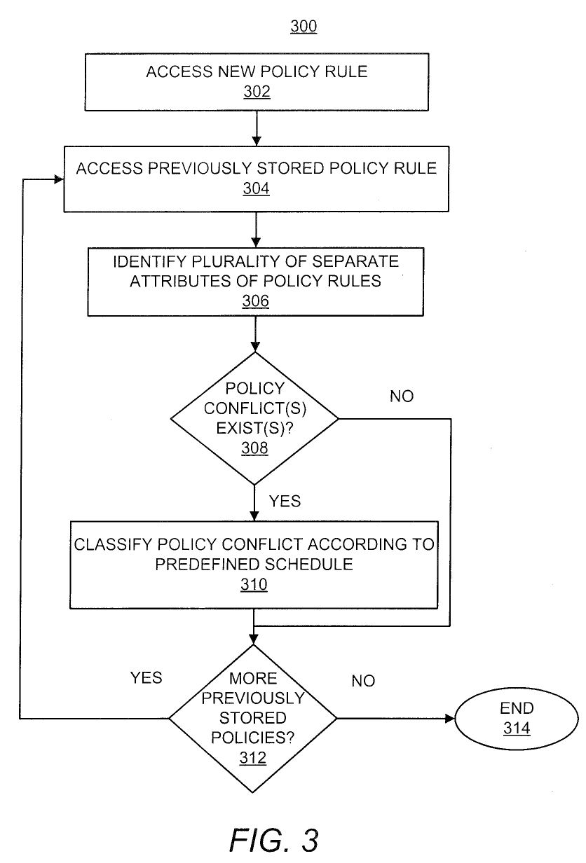

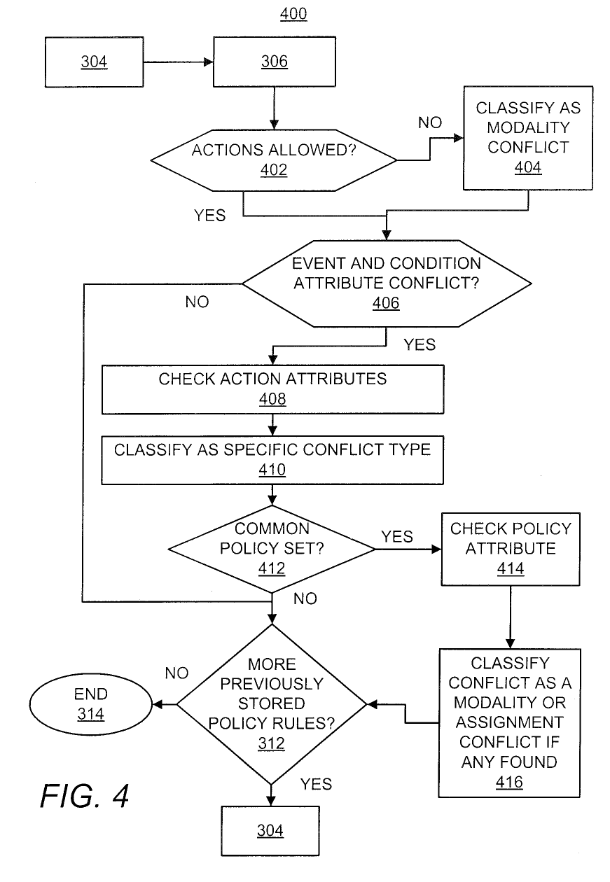

Examples of methods in which the policy conflict classifier 200 may classify a policy conflict are described with respect to the following flow diagrams of the methods 300 and 400 depicted in FIGS. 3 and 4. It should be apparent to those of ordinary skill in the art that the methods 300 and 400 represent generalized illustrations and that other steps may be added or existing steps may be removed, modified or rearranged without departing from the scopes of the methods 300 and 400. In addition, the methods 300 and 400 are described with respect to the policy conflict classifier 200 depicted in FIG. 2 by way of example and not of limitation, and thus, the methods 300 and 400 may be used in other systems or devices.

Some or all of the operations set forth in the methods 300 and 400 may be contained as one or more computer programs stored in any desired computer readable medium and executed by a processor on a computer system. Exemplary computer readable media that may be used to store software operable to implement the present invention include but are not limited to conventional computer system RAM, ROM, EPROM, EEPROM, hard disks, or other data storage devices.

With regard to FIG. 3, there is shown method 300 of classifying policy conflicts for a policy rule 101, according to an embodiment. The method 300 may be applied for a single new policy rule or may be repeated for multiple new policy rules.

At step 302, the access module 202 accesses a policy rule 101 that has been newly entered into the policy conflict classifier 200. For instance, the access module 202 may access the policy rule 101 by receiving the policy rule 101 from a policy rule source 220 and may receive the policy rule 101 as part of a policy rule set. Alternatively, the access module 202 may access the policy rule 101 by retrieving the policy rule 101 from a memory location, such as, the data store 212. Additionally, at step 304, the access module 202 accesses one of the previously stored policy rules 230.

At step 306, the identification module 204 identifies a plurality of separate attributes of the policy rule 101 and the one of the previously stored policy rules 230. For instance, the identification module 204 may identify one or more events, one or more conditions, and one or more actions attribute of the policy rule 101 and the one of the previously stored policy rules 230.

At step 308, the comparison module 206 compares the plurality of separate attributes with attributes of the previously stored policies rule to determine whether one or more policy conflicts exist between the policy rule 101 and the one of the previous stored policy rules.

At step 310, in response to a determination at step 308 that one or more policy conflicts exist, the classification module 208 classifies the one or more policy conflicts according to a predefined schedule 240. For instance, the classification module 208 may classify the one or more policy conflicts as one of predicate conflicts, modality conflicts, and association assignment conflicts. Additionally, the classification module 208 may concurrently or subsequently further classify the classified policy conflict 204. For example, if the policy conflict is classified as a predicate conflict, the classification module may further classify the predicate conflict, using the predefined schedule 240, as a combination of a pre-condition conflict and a post-condition conflict.

At step 312, the policy conflict classifier 200 determines whether there are more previously stored policies to compare with the policy rule 101. In response to a determination at step 312 that there are more previously stored policies to compare, the method 300 thereafter repeats at step 302 with another of the previously stored policy rules 230. The method 300 may repeat for each of the previously stored policy rules and the new policy rule 101. In response to a determination at step 312 that there are no more previously stored policies to compare, the method 300 may end, thereby completing the conflict detection procedure for new policy rule 101 as indicated at step 314.

Turning now to FIG. 4, there is shown method 400 of classifying policy conflicts for a policy rule 101, according to an embodiment. The method 400 comprises a more specific application of the method 300, particularly steps 308-310.

As such, following step 306, at step 402, the comparison module 206 determines whether the action attributes 104 of the policy rule 101 are allowed in view of authorization policies. The authorization policies may define various authorized and unauthorized actions. For example, an authorization policy may indicate that a “file A cannot be deleted except by its owner”. If the action of the policy rule 101 is to delete a file A, and if the policy is executed by a policy administrator who is not the owner of file A, then the authorization policy would prevent the action of “delete file A” from being performed.

At step 404, in response to a determination at step 402 that one or more action attributes on the policy rule 101 are not allowed, the classification module 208 classifies the policy conflict as a modality conflict. Specifically, a determination that an action is not allowed at step 402 represents a conflict between the policy rule 101, which is an obligation policy, with an authorization policy. With the authorization conflict being detected, the method 400 continues to step 406 to check for possible predicate conflicts with previously stored policies.

At step 406, in response to either a determination at step 402 that the action attributes of the policy rule 101 are allowed or following step 404, the comparison module 206 compares event and condition attributes of the policy rule 101 with corresponding event and condition attributes of one of the previously stored policy rules 230, for instance, as accessed at step 304. More particularly, following either of steps 402 and 404, the comparison module 206 may determine whether there is an overlap between one or more of the events and condition attributes of the policy rule 101 and one and more of the events and condition attributes of the previously stored policy rule accessed at step 304. For instance, the comparison module 206 may compare event names, number of occurrences and conditions in a form of attribute operator value to determine whether overlap exists.

Two policies have overlapping event and condition attributes, for instance, when a fact that makes events and conditions of the two policies to both be evaluated to be true exists. More particularly, for instance, two policy conditions/events are overlapping when the program semantics of these two policy conditions/events are not functionally disjointed and logically irrelevant and at least one fact exists to make events and conditions of both policies to be evaluated to be true and thus both action attributes to be executed. For example, Policy condition C1: Person.age >20 and Product-Ordered=Automobile. Policy condition C2: Person.age <100 and Product-Ordered=Car. Whether C1 and C2 are overlapping mainly depends on the program semantics of “automobile” and “car”. If Car is considered one type of Automobile, then Cl and C2 overlap so that a certain fact, such as a person of 30 years old ordered a car, both conditions will be evaluated to be true. If there is no semantic relationship between Automobile and Car, then C1 and C2 do not overlap;

In another example, Policy 1 has an event attribute of a new order arriving, and a condition attribute that a person who placed the order, Person.age >20 and Policy 2 has an event attribute that a new order arrives or an old order is updated, in which the condition attribute is the person who placed the order, Person.age <100. Both actions of the policies will be executed when a new order comes in and the person who placed order is 30 years old.

Moreover, two policy events are overlapping when the program semantics of these two policy events are NOT functionally disjointed and logically irrelevant. For example, Policy event E1: NewCarArrivedEvent OR PriceIncreasedEvent, and Policy event E2: NewAutomobileArrivedEvent. If NewCarArrivedEvent is a subtype of NewAutomobileArrivedEvent, then E1 and E2 are considered overlapping.

The comparison module 206 may also construct an attribute relation table to find overlapping conditions using different but related attribute names, for example automobile.color==red overlaps with car.color==red because car and automobile are related. The rule specification in the foregoing instance refers to java classes and automobile class is a super-class of car class.

In response to a determination at step 406 that the event and condition attributes of the policy rule 101 do not conflict with the event and condition attributes of the previously stored policy rule accessed at step 304, the classification module 208 reports that the event and condition attributes of the policy rule 101 do not conflict with the event and condition attributes of the previously stored policy rule accessed at step 304.

At step 408, in response to either a determination at step 406 that at least one of the event and condition attributes of the policy rule 101 conflicts with at least one of the event and condition attributes of the previously stored policy rule accessed at step 304, the classification module 208 checks action attributes of the previously stored policy rule and the policy rule 101 to determine post-condition conflict types such as contradictions, independencies, redundancies, correlations, etc.

At step 410, the classification module 208 uses the combination of pre-condition conflict types from event/condition attributes and post-condition conflict types from action attributes to determine a specific conflict type for the new policy rule 101 and the previously stored policy rule. For instance, the classification module 208 may classify the policy conflict as any of the policy conflicts discussed above.

At step 412, the classification module 208 determines whether one or more of the attributes of the policy rule 101 and one or more of the attributes of the previously stored policy rule belong to a common policy set. For instance, the classification module 208 may determine whether one or more of the action attributes of the policy rule 101 and one or more of the action attributes of the previously stored policy rules belong to a common policy set. Similarly the classification module 208 may determine whether one or more of the event attributes and/or one or more of the condition attributes of the policy rule 101 and one or more of the event attributes and/or one or more of the condition attributes of the previously stored policy rule belong to a common policy set. Two policies refer to a common policy set or common rule set when they have overlapping event, condition, and action attributes. For instance, policy P1 “Upon event E, when C1, then A” and policy P2 “Upon event E, when C1 or C2, then A” belong to a common policy set because they have a common part that upon event of E, when condition C1 is evaluated to be true, the action A will be executed.

At step 414, in response to a determination that one or more on the attributes of the policy rule 101 and one of more of attributes of the one of the previously stored policy rules 230 belong to a common policy set, the classification module 208 checks the policy association attributes, such as time validity, priority level and access right, of the policy rule 101 and the one of the previously stored policy rule 230 accessed at step 304. In addition, at step 416, the classification module 208 classifies the policy conflict as a modality or assignment conflict if any of these policy conflicts are found at step 414.

Following either the “no” condition at step 412 and step 416, the policy conflict classifier 200 may repeat step 312 as discussed above with respect to the method 300 in FIG. 3.

The classified policy conflicts 250 may be used thereafter to resolve the identified policy conflicts. For instance, given a particular type of policy conflict, an administrator may enact a resolution defined to resolve the particular policy conflict. By way of example in which the policy conflict is a redundancy, in which both condition attributes of the policy rule 101 and a particular one of the previously stored policy rules 230 are redundant, the policy conflict may require intervention from the administrator. For instance, the administrator may determine that the entry of the policy rule 101 was intentional and that a same condition may require actions from both the policy rule 101 and the particular previously stored rule. In addition, or alternatively, the policy conflict classifier 200 may be configured to automatically resolve the policy conflict based on a previously determined priority resolution. For instance, if a policy conflict arises, one policy rule may override the other based on a previously determined priority hierarchy.

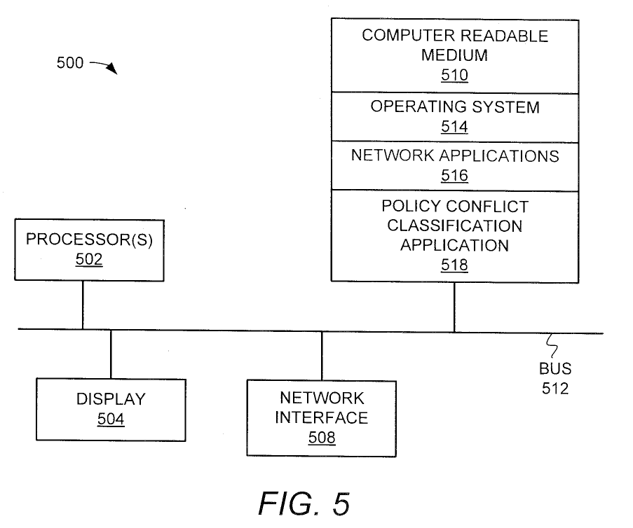

The methods 300 and 400 may be implemented by a computing device, which may be a desktop computer, laptop, server, etc. Turning now to FIG. 5, there is shown a schematic representation of a computing device 500 configured in accordance with embodiments of the present invention. The computing device 500 includes one or more processors 502, such as a central processing unit; one or more display devices 504, such as a monitor; one or more network interfaces 508, such as a Local Area Network LAN, a wireless 802.11x LAN, a 3G mobile WAN or a WiMax WAN; and one or more computer-readable mediums 510. Each of these components is operatively coupled to one or more buses 512. For example, the bus 512 may be an EISA, a PCI, a USB, a FireWire, a NuBus, or a PDS.

The computer readable medium 510 may be any suitable medium that participates in providing instructions to the processor 502 for execution. For example, the computer readable medium 510 may be non-volatile media, such as an optical or a magnetic disk; volatile media, such as memory; and transmission media, such as coaxial cables, copper wire, and fiber optics. Transmission media can also take the form of acoustic, light, or radio frequency waves. The computer readable medium 510 may also store other software applications, including word processors, browsers, email, Instant Messaging, media players, and telephony software.

The computer-readable medium 510 may also store an operating system 514, such as Mac OS, MS Windows, Unix, or Linux; network applications 516; and a policy classification application 518. The operating system 514 may be multi-user, multiprocessing, multitasking, multithreading, real-time and the like. The operating system 514 may also perform basic tasks such as recognizing input from input devices, such as a keyboard or a keypad; sending output to the display 504; keeping track of files and directories on medium 510; controlling peripheral devices, such as disk drives, printers, image capture device; and managing traffic on the one or more buses 512. The network applications 516 include various components for establishing and maintaining network connections, such as software for implementing communication protocols including TCP/IP, HTTP, Ethernet, USB, and FireWire.

The policy conflict classification application 518 provides various software components for classifying policy conflicts, as described above. In certain embodiments, some or all of the processes performed by the application 518 may be integrated into the operating system 514. In certain embodiments, the processes can be at least partially implemented in digital electronic circuitry, or in computer hardware, firmware, software, or in any combination thereof, as also discussed above.

Embodiments of the present invention provide a method and apparatus for classifying policy conflicts. The method and apparatus are generally configured to assist an administrator in identifying specific types of conflicts in a policy specification so that upon receiving detection information for policy conflicts, the administrator may correct the policy specification to obviate or otherwise manage the policy conflicts more easily as compared with conventional conflict detection systems.

What has been described and illustrated herein are embodiments of the invention along with some of their variations. The terms, descriptions and figures used herein are set forth by way of illustration only and are not meant as limitations. Those skilled in the art will recognize that many variations are possible within the spirit and scope of the invention, wherein the invention is intended to be defined by the following claims—and their equivalents—in which all terms are meant in their broadest reasonable sense unless otherwise indicated.

What is claimed is:

1. A method for classifying policy conflicts in a managed system, the method comprising:
identifying a plurality of separate attributes of a policy rule;
determining, using a processor, whether one or more policy conflicts exist by comparing the plurality of separate attributes with attributes of previously stored policy rules; and
classifying the one or more policy conflicts as one or more types of conflicts according to a predefined schedule, in response to a determination that one or more policy conflicts exist.

2. The method of claim 1, wherein identifying the plurality of separate attributes further comprises:
identifying at least one event, at least one condition and at least one action of the policy rule.

3. The method of claim 2, wherein the predefined schedule comprises:
predicate conflicts, said predicate conflicts including logical inconsistencies across rule sets;
modality conflicts, said modality conflicts including conflicting modalities referring to at least one common rule set; and
association assignment conflicts, said association assignment conflicts including inconsistent priorities and assignments referring to at least one common rule set.

4. The method of claim 3, wherein the predicate conflicts further comprise:
pre-condition conflicts, said pre-condition conflicts including inconsistencies between event and condition attributes of at least two rule sets; and
post-condition conflicts, said the post-condition conflicts including inconsistencies between action attributes of at least two rule sets.

5. The method of claim 4, wherein the pre-condition conflicts further comprise:
contradictions that occur when the conditions of the policy rule and the previously stored policy rule are a negation of each other and refer to a same event and action;
correlations that occur when an event or a condition of one of the policy rule and the previously stored policy rule is a conjunctive subset of another event or condition and refer to a same event and action of the policy rule and the previously stored policy rule;
redundancies that occur when an event or a condition of one of the policy rule and the previously stored policy rule is a disjunctive subset of another event or condition and refer to a same event and action of the policy rule and the previously stored policy rule; and
intersections that occur when an event or a condition of the policy rule intersects with another event or condition and refer to a same event and action of the policy rule and the previously stored policy rule.

6. The method of claim 4, wherein the post-condition conflicts comprise:
contradictions that occur when action attributes of the policy rule and the previously stored policy rule are mutually exclusive with each other and refer to a same event and condition of the policy rule and the previously stored policy rule;
independencies that occur when action attributes of the policy rule and the previously stored policy rule are independent of each other and refer to a same event and condition of the policy rule and the previously stored policy rule;
redundancies that occur when an action is a subset of another action and refer to a same event and condition of the policy rule and the previously stored policy rule; and
correlations that occur when an action intersects with another action and refer to a same event and condition of the policy rule and the previously stored policy rule.

7. The method of claim 3, wherein the modality conflicts further comprise:
time validity conflicts that occur when there are inconsistencies between time validities of the policy rule and the previously stored policy rule and refer to common policy sets; and
authorization conflicts that occur when there are inconsistencies between authorizations and obligations of the policy rule and the previously stored policy rule.

8. The method of claim 3, wherein the association assignment conflicts further comprise:
priority assignment conflicts that occur when there are inconsistencies between priorities of the policy rule and the previously stored policy rule and refer to at least one common rule set; and
access rights conflicts that occur when there are inconsistencies between access rights of the policy rule and the previously stored policy rule and refer to at least one common rule set.

9. The method of claim 1, wherein determining whether one or more policy conflicts exist further comprises:
determining whether action attributes of the policy rule are allowed in view of authorization policies;
classifying the policy conflict as a modality conflict in response to a determination that one or more of the action attributes of the policy rule are not allowed;
comparing event and condition attributes of the policy rule with event and condition attributes of the previously stored policy rules;
reporting that the event and condition attributes of the policy rule do not conflict with the event and condition attributes of the previously stored policy rules in response to a determination that the event and condition attributes of the policy rule do not conflict with the event and condition attributes of the previously stored policy rules;
classifying the policy conflict as a specific conflict type in response to a determination that one or more of the event, condition, action attributes of the policy rule conflicts with one or more of the event, condition and action attributes of the previously stored policy rules;
checking the policy attribute in response to a determination that one or more of the attributes of the policy rule and one or more of the attributes of the previously stored policy rules belong to a common policy set; and
classifying the policy conflict as at least one of a modality or assignment conflict in response to the at least one of the modality and assignment conflicts existing.

10. A policy conflict classifier comprising:
one or more modules configured to identify a plurality of separate attributes of the policy rule, determine whether one or more policy conflicts exist by comparing the plurality of separate attributes of the policy rule with attributes of previously stored policies, and in response to a determination that one or more policy conflicts exists, to classify the one or more policy conflicts according to a predefined schedule; and
a processor configured to implement the one or more modules.

11. The policy conflict classifier of claim 10, wherein at least one of the one or more modules is further configured to identify an event, a condition and an action of the policy to identify the plurality of separate attributes.

12. The policy conflict classifier of claim 10, wherein the predefined schedule comprises:
predicate conflicts, said predicate conflicts including logical inconsistencies across rule sets,
modality conflicts, said modality conflicts including conflicting modalities referring to at least one common rule set, and
association assignment conflicts, said association assignment conflicts including inconsistent priorities and assignments referring to at least one common rule set.

13. The policy conflict classifier of claim 12, wherein the predicate conflicts further comprise:
pre-condition conflicts, said pre-condition conflicts including inconsistencies between event and condition attributes of at least two rule sets; and
post-condition conflicts, said post-condition conflicts including inconsistencies between action attributes of at least two rule sets.

14. The policy conflict classifier of claim 13, wherein the pre-condition conflicts further comprise:
contradictions that occur when the conditions of the policy rule and the previously stored policy rule are a negation of each other and refer to a same event and action;
correlations that occur when an event or a condition of one of the policy rule and the previously stored policy rule is a conjunctive subset of another event or condition and refer to a same event and action;
redundancies that occur when an event or a condition of one of the policy rule and the previously stored policy rule is a disjunctive subset of another event or condition and refer to a same event and action of the policy rule and the previously stored policy rule; and
intersections that occur when an event or a condition of the policy rule intersects with another event or condition and refer to a same event and action of the policy rule and the previously stored policy rule.

15. The policy conflict classifier of claim 13, wherein the post-condition conflicts further comprise:
contradictions that occur when action attributes of the policy rule and the previously stored policy rule are mutually exclusive with each other and refer to a same event and condition of the policy rule and the previously stored policy rule;
independencies that occur when action attributes of the policy rule and the previously stored policy rule are independent of each other and refer to a same event and condition of the policy rule and the previously stored policy rule;
redundancies that occur when an action is a subset of another action and refer to a same event and condition of the policy rule and the previously stored policy rule; and
correlations that occur when an action intersects with another action and refer to a same event and condition of the policy rule and the previously stored policy rule.

16. The policy conflict classifier of claim 12, wherein the modality conflicts further comprise:
time validity conflicts that occur when there are inconsistencies between time validities of the policy rule and the previously stored policy rule and refer to common policy sets; and
authorization conflicts that occur when there are inconsistencies between authorizations and obligations of the policy rule and the previously stored policy rule.

17. The policy conflict classifier of claim 12, wherein the association assignment conflicts further comprise:
priority assignment conflicts that occur when there are inconsistencies between priorities of the policy rule and the previously stored policy rule and refer to at least one common rule set; and
access rights conflicts that occur when there are inconsistencies between access rights of the policy rule and the previously stored policy rule and refer to at least one common rule set.

18. A computer readable storage medium storing at least one computer program that when executed performs a method of classifying policy conflicts, the method comprising:
identifying a plurality of separate attributes of a policy rule;
determining, using a processor, whether one or more policy conflicts exist by comparing the plurality of separate attributes with attributes of previously stored policy rules; and
classifying the one or more policy conflicts according to a predefined schedule, in response to a determination that one or more policy conflicts exist.

19. The computer readable storage medium according to claim 18, said one or more computer programs further including a set of instructions for:
identifying at least one event, at least one condition and at least one action of the policy rule.

20. The computer readable storage medium according to claim 18, wherein the predefined schedule comprise:
predicate conflicts that include logical inconsistencies across rule sets;
modality conflicts that include conflicting modalities referring to at least one common rule set; and
association assignment conflicts that include inconsistent priorities and assignments referring to at least one common rule set.
